(19) United States
(12) Patent Application Publication
(10) Pub. No.: US 2019/0286695 A1
(43) Pub. Date: Sep. 19, 2019

(54) Left-to-Right Parser for Tree-adjoining Grammar

(71) Applicant: Nen Van Huynh, GARDEN GROVE, CA (US)

(72) Inventor: Nen Van Huynh, GARDEN GROVE, CA (US)

(21) Appl. No.: 15/924,182

(22) Filed: Mar. 17, 2018

(51) Int. Cl. G06F 17/27; G06F 17/30

(52) U.S. Cl. CPC G06F 17/2705; G06F 17/277; G06F 17/30684; G06F 17/30625

(57) ABSTRACT

A method and system for parsing a tree-adjoining grammar (TAG). A grammar parser reads in a sequence of tokens and determines if the sequence is valid in the grammar. It uses a matrix-vector representation of the TAG and performs parsing one token at a time. The innovation is the use of matrices and vectors to efficiently store the grammar and perform the parsing using these matrices and vectors.

### FIELD OF THE INVENTION

The invention relates to the parsing of sequences of symbols, such as sentences. More specifically, the invention relates to systems and methods that determine if such a sequence of tokens, such as symbols, form a valid string from a provided grammar. The invention covers grammars that are Tree-adjoining Grammars (TAG) or grammars that can be rewritten as Tree-adjoining Grammars. FIG. 1 (without the numbers) shows an example of a storage of Tree-adjoining grammars. The exact definition of a Tree-adjoining Grammar is better explained outside of this patent document. The inventor refers to “Tree-Adjoining Grammars” by Aravind K. Joshi and Yves Schabes in Rozenberg G., Salomaa A. (eds) Handbook of Formal Languages. Springer, Berlin, Heidelberg for a thorough description.

A parsing device, system or method (which we will call a parser) converts a sequence of symbols into an organized structure, potentially for further processing. A parsing is essential for communications involving computer interaction both with humans, such as natural language, and with other computers. Before or during parsing, the sequence may be grouped together or tagged with information, forming what can be called a sequence of tokens. Although tokens can be in general anything, tokens are usually groups of symbols joined together. For example, for a sentence, the sequence of tokens is usually a sequence of words in such sentence.

For rule-based grammars, such as Tree-adjoining Grammars (TAG), the sequence must be of a specific form relative to a given grammar. In this case, the parser may also flag whether the sequence of symbols is valid, relative to such grammar. Furthermore, if the parser is specifically designed to be a parser that reads the sequence one token at a time say from left-to-right, the parser is then to tell if the token recently fed into the parser is a valid new token in the grammar. Conversely, the parser may also provide a list of tokens, each token being a valid proceeding token fed into the parser. Hence, the parser can also be interactive with a user, providing hints and predictions.

Here, the patent is focused on left-to-right parser systems which read one token at a time, which has the benefit of providing an interactive environment for error checking and token prediction for Tree-adjoining Grammars.

### BACKGROUND OF THE INVENTION

Since the introduction of Tree-adjoining Grammars (TAG), there have been attempts to obtain an efficient parsing method for such grammars. TAG was introduced in the article entitled “String adjunct grammars” by A. K. Joshi et. al. appearing in IEEE Conference Record of 10th Annual Symposium on Switching and Automata Theory. Although different approaches have been attempted, they are primarily paradigms for context-free grammars. Notable ones include Cocke-Younger-Kasami (in article entitled “Some computational properties of tree adjoining grammars” by K. Vijay-Shankar and A. K. Joshi in Proceedings of the 23rd annual meeting on Association for Computational Linguistics, ACL '85), Earley style (in article entitled “An Earley-type parsing algorithm for tree adjoining grammars” by Y. Schabes and A. K. Joshi in Proceedings of the 26th annual meeting on Association for Computational Linguistics, ACL '88), and left-to-right style (in article entitled “Deterministic left to right parsing of tree adjoining languages” by Y. Schabes and K. Vijay-Shanker in Proceedings of the 28th Annual Meeting on Association for Computational Linguistics, ACL '90 and in article entitled “Left to right parsing of lexicalized tree-adjoining grammars” by Y. Schabes in Computational Intelligence, 1994). The one we will focus on will be left-to-right (LR) parsers (and Earley parser because the Earley parser also reads from left to right but refers to a specific style from LR parsers). The advantage of having a left-to-right (LR) parser is that because the string is parsed one token at a time, grammatical errors can be caught in the middle of parsing, predictions can be made for what token(s) is expected in the string, report of optional early termination of the strings can be done and interactive string completion can be performed.

For TAG left-to-right parser, there are only a few reported (prior-art) parsers. The two are an embedded pushdown automaton method (in article entitled “Deterministic left to right parsing of tree adjoining languages” by Y. Schabes and K. Vijay-Shanker in Proceedings of the 28th Annual Meeting on Association for Computational Linguistics, ACL '90) and a lexicalized TAG method (in article entitled “Left to right parsing of lexicalized tree-adjoining grammars” by Y. Schabes in Computational Intelligence, 1994). It should be noted that abstractly, Earley style methods are close in form to LR parsers that they should also be considered as prior art. For TAG, Earley TAG parsers are extensions of the original Earley parser for context-free grammars.

However, these reported parsers lack a good time complexity and small storage footprint. Embedded pushdown automaton consumes a large amount of storage since it employs a stack data structures inside a stack data structure, causing it to spend too much time manipulating data. The parser for article “Left to right parsing of lexicalized tree-adjoining grammars” has a large time complexity. Earley TAG parsers have the advantage of being based on a fast context-free grammar but it is not a true LR parser.

The solution to these issues involve the use of a matrix-vector representation of tree-adjoining grammar, the representation of the parsing states using what will be defined as a string tree (and corresponding construction directions, also defined later), and a unique analysis of the different possible parsing states. Further discussion is presented in the next section.

### SUMMARY THE INVENTION

As mentioned, the purpose of the invention is to parse a Tree-adjoining Grammar (TAG) from a left-to-right (LR) fashion by reading one token at a time. FIG. 3 shows the steps to perform the parsing invention. FIG. 4 shows the parsing invention as a block diagram. The parser will determine if the current state of parsing is a valid one, if the string (a sequence of tokens) can immediately terminate, and predict the next possible token(s) that may follow the current string; the parser is not required to contain all of these elements. As a benefit, the parser should also do it efficiently in both time and storage.

To achieve this, the Tree-adjoining Grammar is converted into a matrix-vector representation (MVR) before any parsing occurs. The parser starts by labeling the trees in TAG with a unique identifier, called a label, such as the numbers shown in FIG. 1. From the identifiers, the TAG is then uniquely represented as a storage of matrices and vectors (or, alternatively, a list of labels). The parser will then use the MVR to parse tokens.

The MVR will contain, among other objects, a vector (or list) representing the storage of possible tokens that can be the first token of a string. When the first token is read into the parser, such token is compared to the vector (or list) to determine if it is a valued starting token. If it is, the parser will provide a storage of label trees with corresponding reference to a node in the label tree (shown in FIG. 5 and FIG. 6 as an example) or an equivalent object to it, such as a sequence of directions to construct the label trees, which we will call construction directions. We will call these two equivalent objects (and other alternative representation) a parsing state. Specifically, a label tree is a tree data structure whose nodes each contain a label or is empty and a construction direction is a sequence of tokens that represent the construction of a label tree; FIG. 6 shows a diagram of a label tree and FIG. 7 shows a diagram of a list of construction directions. Also, the parser may report if no more tokens are necessary for the string to be complete or provide a storage of possible next tokens that the parser will later expect. In detail, the parser does this by trying to predict an update to the label trees. If at least one of the updates produces a finished label tree (or something equivalent to it), then the string can be terminated immediately. A finished label tree is a label tree with nodes being empty or containing labels that correspond to root nodes of the TAG. Similarly, the finished label tree can also have alternative representations, such as a construction direction; we will then denote the finished label tree and it's alternative to be a finished state.

When the next token is fed into the parser (shown in FIG. 2 as an example), the parser will use the storage of parsing states and try to update them to new states so that the next possible token(s) can be predicted. The next token is read and all new states that do not predict this read token is discarded while those that do, become the parsing states. If all the new states are discarded, then the parser will report that the recently fed token is not valid. The process is then repeated. If an update results in a finished label tree (or finished state for short), then the sequences can optionally be terminated early.

If there are no more tokens to be read, the parser looks at the previous updates to the label trees. If none of the updates result in a finished label tree, the parser reports that the sequence of tokens is not valid.

In summary, the invention concerns the parsing of Tree-adjoining Grammars (TAG) using the labeling of the trees in it, as shown FIG. 1, and constructing a unique matrix-vector representation (MVR) of the grammar. The MVR is then used to parse one token at a time to determine if the sequence of tokens is a valid string according to the TAG. The parser construct parsing states that contain the information about the current and previous tokens using a data structure, such as a label tree or construction direction, containing the labels of the TAG.

### BRIEF DESCRIPTION OF THE DRAWINGS

FIG. 1 shows an example TAG. Here, there are ten TAG trees that define the grammar and there are 48 labels used to mark the nodes in the TAG trees. Leaf and root nodes will have one label while other nodes will have two (left and right) labels. The tokens are shown with quotations for the parser to match to. Nodes with designation R are root nodes of initial trees or substitution nodes that must be joined with initial trees that have R as the root node. Designation R will also serve as the distinguished token; the token that is required to be the root of all derived trees. Nodes with designation a are root nodes of auxiliary trees, foot nodes or adjunction nodes that must be joined with auxiliary trees that have designation a as the root node. Nodes with designation o are root nodes of auxiliary trees, foot nodes or adjunction nodes that are optionally joined with auxiliary trees that have o as the root node.

FIG. 2 shows an example token fed into the parser. The token will usually be sequence of characters from a string. In this example, the string is a single-character string “r”.

FIG. 3 shows the flow chart of the parsing process, based on this invention. The matrix-vector representation (MVR) is constructed before parsing can begin. Next, the tokens are read one at a time and the parsing states are to be updated based on the read token and predicted next token. Parsing states are checked in step 108 and 110 to see if they match the read token in step 107. And finished states are checked to see if they are present in step 109. They both determine whether the sequence of tokens is valid. See Embodiment of TAG Parser section for step-by-step details.

FIG. 4 shows the block diagram of the parsing process, based on this invention. It shows the block diagram equivalent of FIG. 3. MVR is block 202 from the TAG in step 200. The input token is read at blocks 201 and 209. The parsing states are updated at block 203, filtered at block 207, updated at block 204 and outputted as block 206. Finished states are outputted as well as block 205. Block 208 and block 205 determines if the sequence of tokens is valid. See Embodiment of TAG Parser section for step-by-step details.

FIG. 5 shows the components of the initial label tree and the information that influences it. The MVR contains what labels can be in the initial label tree so from the input token, a label k is determined to have the same token as the input token. The reference a will then reference the node containing labelk. The tree and the reference is then part of the starting parsing state.

FIG. 6 shows an example of a storage of parsing and new state objects that are the inputs and outputs for the parser. The states contain a label tree containing labels from the TAG and corresponding references σ₁ and σₘ that reference nodes containing labels p and q, respectively.

FIG. 7 shows an example of a storage of construction directions used as the alternative representation of label trees. Here, the construction direction is a sequence of instructions to build or update a label tree based on the input token and MVR. For example, the ↑ and ↓ corresponds to moving the reference up and down, respectively; the large numbers mean the reference node is assigned to contain that number; the +↓₂ means a new node is inserted as the second child of the reference node and the reference is moved to the new node; and the +↓_{2,1} means a new node is inserted between the reference node and its parent node so that the new node is the second child of the parent, the reference node is reinterpreted as the first child and the reference is later moved to the new node.

FIG. 8 shows the data structure of the Direction Construction (DC) when a Label Tree (shown on the left side) and a reference to a node in that tree (shown under the Label Tree) is inputted into the Direction Construction (DC). It serves as the detailed realization of step 105 of FIG. 3 and the Update Parsing State block (block 204) of FIG. 4 where the pair Label Tree and reference is the starting/updated state object of FIG. 4 and block 205 and 206 show the realization of the finished states and not finished states of FIG. 4 as a storage of lists of numerical values and instructions (shown as arrows, + symbol and subscripts). Once inputted, three storage data structures L, C and Γ are updated (shown as three rows of boxes on the top side). The first storage data structure L contains construction directions for label trees that are called not finished label trees. The second data structure C contains construction directions for label trees that are called finished label trees. The third storage data structure Γ contains a pair of an updated list of construction directions and a reference to a label tree node. When the Label Tree and reference to a node of that Label Tree is first inputted, the third storage data structure will initially contain the pair [(1+p); σ] where σ is the reference to the label tree node inputted into the Direction Construction and (1+p) is a list with a single element: an 1+p where p is a numerical value inside the node referenced by σ. The instructions on how the three storage data structures are updated are given as steps 300-312. See Embodiment of TAG Parser section for step-by-step details.

FIG. 9 shows block A referenced in FIG. 8. Block A uses labels k from FIG. 8 and iterator i to finds all nonzero elements of the matrix EN̅ determine whether to store construction directions into storage data structures L. See Embodiment of TAG Parser section for step-by-step details.

FIG. 10 shows block B referenced in FIG. 8. Block B uses label k from FIG. 8 and iterator i to find terminal or foot labels greater than k and either nonzero Ī[k, i] or Ī[i, i+1] to construct construction directions that are stored into either storage data structures Γ or L. See Embodiment of TAG Parser section for step-by-step details.

FIG. 11 shows block C referenced in FIG. 8. Block C uses label k from FIG. 8, block C1 from FIG. 12 and block C2 from FIG. 13 to construct construction directions that are stored into either storage data structures Γ or L. See Embodiment of TAG Parser section for step-by-step details.

FIG. 12 shows block C1 referenced in FIG. 11. Block C1 handles the case of when the reference node of Block C, step 601, has an empty ∈(k)-th child and when Block C2 has finished executing. Block C1 tests to see whether to insert the pair of a construction direction and a reference is stored into storage data structure F. See Embodiment of TAG Parser section for step-by-step details.

FIG. 13 shows block C2 referenced in FIG. 11. Block C2 handles the case of when the reference node of Block C, step 601, does not have an empty ∈(k)-th child. Block C2 tests to see whether to insert a construction direction is stored into storage data structure L. Instruction passes to block C1, step 612, when block C2 instruction is finished. See Embodiment of TAG Parser section for step-by-step details.

FIG. 14 shows block D referenced in FIG. 8. Block D uses label k, label m in the parent node of reference node σ, vector s₀, vectors, matrix R_{A}, matrix EN̅, matrix I, matrix A_{S} and block FC to determine whether to construct construction directions that are stored into either storage data structures Γ or L. See Embodiment of TAG Parser section for step-by-step details.

FIG. 15 shows block E referenced in FIG. 8. Block E uses label k, label m in the parent node of reference node σ, matrix E, block E1, block E2 and block E3 to determine whether to construct construction directions that are stored into either storage data structures Γ or L. See Embodiment of TAG Parser section for step-by-step details.

FIG. 16 shows block E1 referenced in FIG. 15. Block E1 handles when reference node σ, of block E, does not have a parent. Block E1 uses label k, matrix I, matrix E^{T}, matrix N̅, vector γ, vector ∈ and block FC whether to construct construction directions that are stored into either storage data structures Γ or L. See Embodiment of TAG Parser section for step-by-step details.

FIG. 17 shows block E2 referenced in FIG. 15. Block E2 handles when reference node σ, of block E, does have a parent and the parent label is an R-side. Block E2 uses label k, matrix E^{T}, matrix EN̅, vector s₀, vector ∈ and block FC whether to construct a pair of construction directions with reference node σ that are stored into storage data structure Γ. See Embodiment of TAG Parser section for step-by-step details.

FIG. 18 shows block E3 referenced in FIG. 15. Block E3 handles when reference node σ, of block E, does have a parent and the parent label is not an R-side. Block E3 uses label k, label m in the parent node of reference node σ, matrix E^{T}, matrix EN̅, vector s₀, vector ∈ and block FC whether to construct construction directions that are stored into either storage data structures Γ or L. See Embodiment of TAG Parser section for step-by-step details.

FIG. 19 shows block F referenced in FIG. 8. Block F uses label k, label m in the parent node of reference node σ, matrix EN̅, block F1, block F2 and block F3 to determine whether to construct construction directions that are stored into either storage data structures Γ or L. See Embodiment of TAG Parser section for step-by-step details.

FIG. 20 shows block F1 referenced in FIG. 19. Block F1 handles when reference node σ, of block F, does not have a parent. Block F1 uses label k, vector γ, matrix N̅P₁, matrix F̅_̅{̅N̅}̅ and block FC to determine whether to construct construction directions that are stored into either storage data structures Γ or L. See Embodiment of TAG Parser section for step-by-step details.

FIG. 21 shows block F2 referenced in FIG. 19. Block F2 handles when reference node σ, of block F, has a parent. Block F2 uses label k, label m in the parent node of reference node σ, matrix I, matrix EN̅P₁, matrix F̅_̅{̅N̅}̅ and block FC to determine whether to construct construction directions that are stored into either storage data structures Γ or L. See Embodiment of TAG Parser section for step-by-step details.

FIG. 22 shows block F3 referenced in FIG. 19. Block F3 handles when reference node σ, of block F, has a parent containing R-side label m. Block F3 uses label k, label m in the parent node of reference node σ, matrix I, matrix EN̅P₁, matrix F̅_̅{̅N̅}̅ and block FC to determine whether to construct construction directions that are stored into either storage data structures Γ or L. See Embodiment of TAG Parser section for step-by-step details.

FIG. 23 shows block FC referenced in multiple figures. Block FC is initialized with a construction directions [symbol] as input, with the last element being a tree node label k, and initialized with an empty list of construction directions L. It starts with steps 1000-1001 and checks label k to find construction directions to store into storage data structure L.

FIG. 24 shows the construction of matrix R_{A}. Matrix R_{A} is an n-by-n matrix where n is the number of tree node labels and each entry of matrix R_{A} is initialized with the value zero. First, the storage of labels i that is a storage of root node labels of auxiliary trees (such as labels 5, 8, 13, 28, 33, 36, 43 and 48 for FIG. 1) are considered. The construction of R_{A} then iterates through all of these labels by performing assignment j=1+f(i), performs a check on whether j is less than the root node label and so on so that assignment occurs at R_{A}[k, s(j)]=1. When there is no more i's to iterate, no more assignment occurs. See Embodiment of MVR section for the step-by-step details.

FIG. 25 shows the construction of matrix F_{A}. Matrix F_{A} is an n-by-n matrix where n is the number of tree node labels and each entry of matrix F_{A} is initialized with the value zero. The construction proceeds similar to the construction of R_{A}. The construction iterates over the storage of all foot node labels i and termination occurs when there is no more i or if there was none to begin with. See Embodiment of MVR section for the step-by-step details.

FIG. 26 shows the construction of matrix F_{B}. Matrix F_{B} is an n-by-n matrix where n is the number of tree node labels and each entry of matrix F_{B} is initialized with the value zero. The i-th row and k-th column of matrix F_{B} is assigned the value 1 if label i is a foot node label, k is a left side label and has the same token as label i, Ī[j+1, k]>0, and j is a foot label of auxiliary tree u satisfying the condition of step 1302. See Embodiment of MVR section for the step-by-step details.

FIG. 27 shows the construction of matrix A_{S}. Matrix A_{S} is an n-by-n matrix where n is the number of tree node labels and each entry of matrix A_{S} is initialized with the value zero. The construction of A_{S} is similar to F_{B}, with step 1403 checking if the foot node label i has the same token as the root node of auxiliary tree u. If so, an assignment of one is made to the i-th row and j-th column of matrix A_{S} where j is the starting label of TAG tree u. See Embodiment of MVR section for the step-by-step details.

### DETAILED DESCRIPTION OF THE PREFERRED EMBODIMENTS

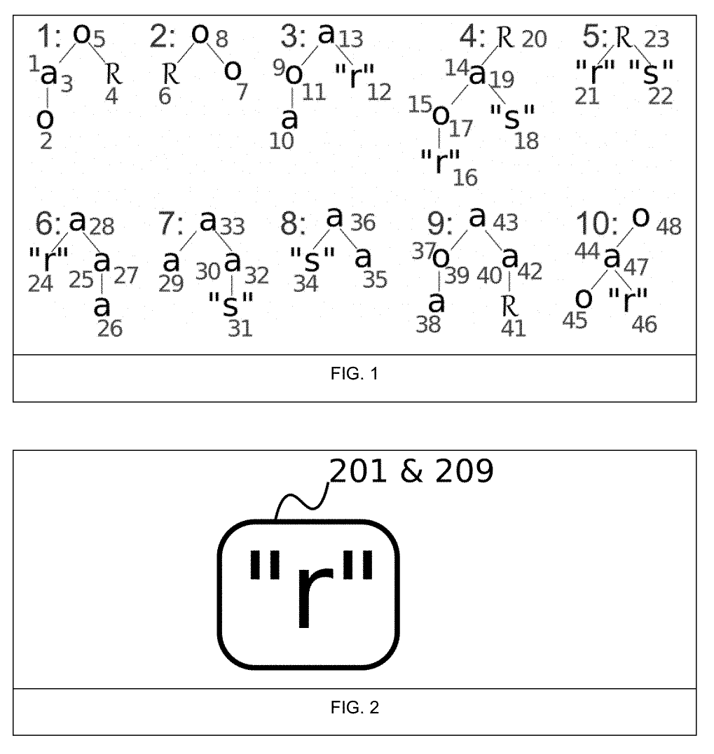

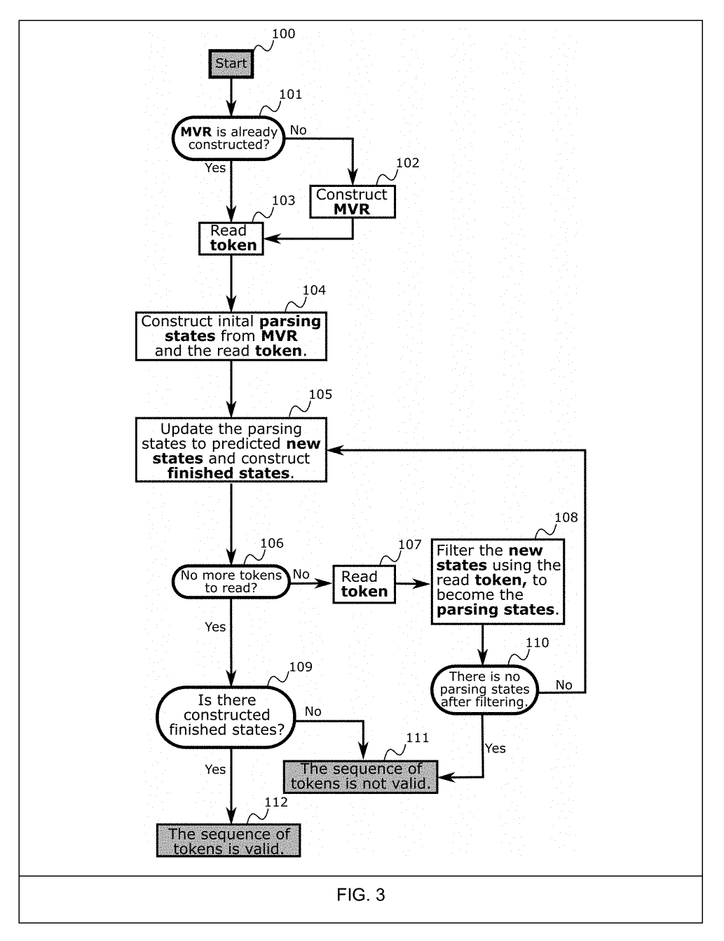

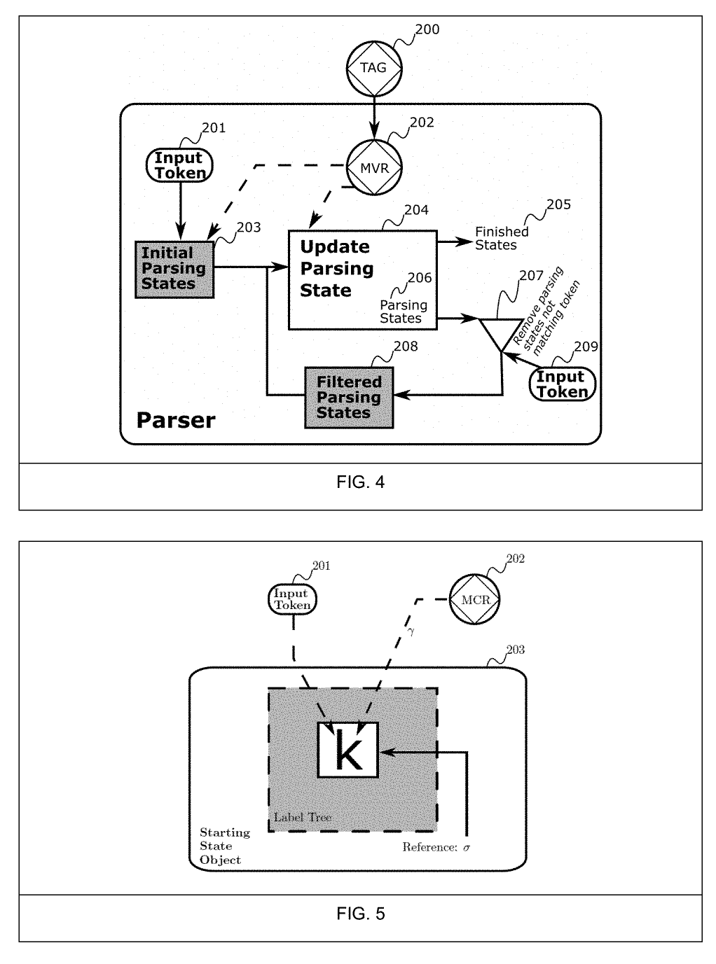

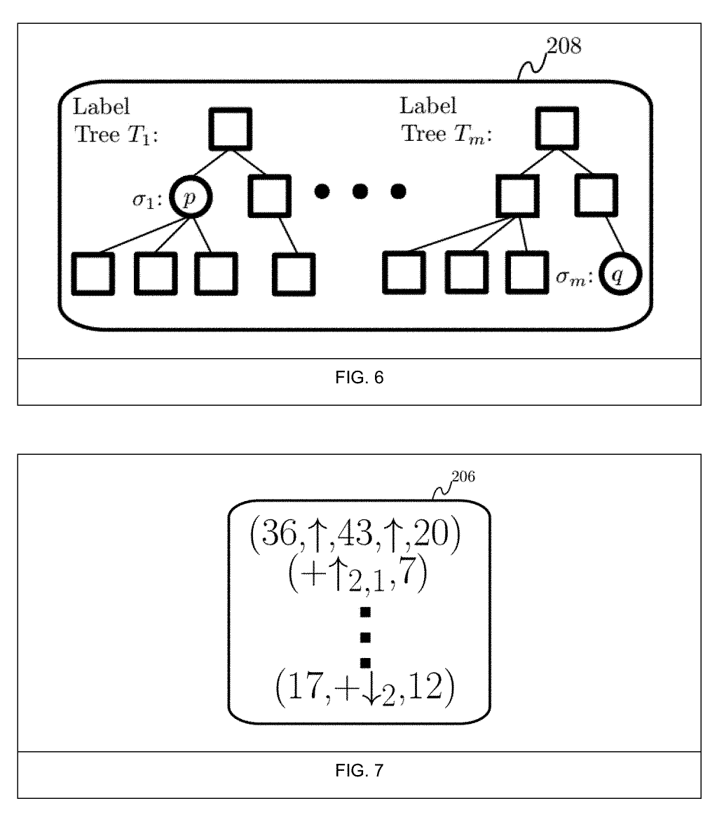

As shown in FIG. 3 and FIG. 4 the matrix-vector representation (MVR) of the tree-adjoining grammar (TAG) must be first constructed. In general, the MVR of a TAG is any storage of matrices and vectors that uniquely describe the TAG. This patent focuses on an MVR that is used by the parser to efficiently look up needed information about the TAG and, preferably, the MVR will have a sufficiently small memory footprint. To construct the MVR, the parser starts by looking at the storage of TAG trees such as ones shown in FIG. 1 and assigning at least one unique label to each of the tree nodes, which are shown as numbers on the left or right side of the tree nodes. From these labels, the MVR can be constructed. It should be mentioned that although MVR is a storage of matrices and vectors, it can be substituted with a list, tree or many other data structures since they can contain the same information as the matrices and vectors of MVR. For example, because the matrices of the MVR tend to be sparse, it may be more storage-efficiently replaced with a list containing pairs of integers denoting the location on the matrix that is nonzero.

### Embodiment of MVR

We show an embodiment of the MVR. Define n to be the number of labels. For the remainder of this patent, i+1 is assumed to be the label after i if there exists one.

We start by defining vector (γᵢ)_{i≤n} a Boolean on whether label i is a starting terminal label of a TAG tree, vector s₀=(s₀(i))_{i≤n} to contain the starting label of the TAG tree containing label i, vector s to be the left and right side label correspondence, and vector ∈ to be a label to child index correspondence vector.

For 1≤i≤n,

$${γ}_{i} = \{ \begin{matrix}1 , & if label i is a starting terminal label , \\ 0 , & otherwise .\end{matrix}$$

s₀(i)=the starting label of the TAG tree which contains label i.

$$s ( i ) = \{ \begin{matrix}{s}_{0} ( i ) , & if i is a root label , \\ j , & \begin{matrix}if i is on the left or right side and \\ j is on the opposite side of i ,\end{matrix} \\ 0 , & otherwise .\end{matrix}$$

∈(k)=i if label k is associated with the i-th child index. Specifically, each adjunction and substitution node may be inserted with another TAG tree during tree derivation. In the label tree form, the label k will be in a label tree node and it's i-th child will be a node containing a label from such TAG tree.

Matrix I is an n×n matrix that transitions from one label to the follow-up label in the same TAG tree if there exists a derived tree that still has these two labels connected to each other. As an embodiment, its elements are zeros except for the conditions below.
For label i is on the left side, I[i,i+1]=1 if there exists a derived tree such that if one follows the left-hand path from label i down, one will reach label i+1 without encountering a terminal node label. If no derived tree exists that satisfies this condition, then I[i, i]=1.
For label i is on the right side, I[i, i+1]=1 if label i is an optional adjunction node. Otherwise, I[i, i]=1.
If label i is neither, I[i, i]=1.

Matrix Ī considers a sequence of label transitions from I. As an embodiment,

$$\overline{I} = {( 𝕀 - \frac{I}{2 ‖ I ‖} )}^{- 1}$$

where II is the identity matrix.

Matrix E is an n×n matrix that transitions from one label to another label of another TAG tree label if the two labels are connected in a derived tree. As an embodiment, its elements are zeros except for the conditions below.
For label i is on the right side, E[i,j+1]=1 if there exists a derived tree such that if one follows the right-hand path from label i up, one will reach label j+1 where label j is a label to a foot node.
For label i is not on the right side, E[i, i+1]=1 if there exists a derived tree such that if one follows the left-hand path from label i down, one will immediately reach label j where label j is a starting label.

Matrix N considers both connections in I and E. Similarly, N̅ considers a sequence of label transitions from N. As an embodiment, N=I+E and

$$\overline{N} = {( 𝕀 - \frac{N}{2 ‖ N ‖} )}^{- 1} .$$

Matrix P₁ is an n×n matrix that transitions from one label to the follow-up label in the same tree. As an embodiment, its elements are zeros except for the conditions below.
For label i is on the right side and i is not a root node, P₁[i, i+1]=1. Otherwise, P₁[i,i]=1.
For label i is not on the right side, P₁[i, i+1]=1.

Vectors f̅ and f considers the foot node label transitions. As an embodiment,

$$\overline{f} ( i ) = \{ \begin{matrix}j , & \begin{matrix}if i is a label of an auxiliary tree , \\ j is the label for the foot node of such tree and there exists \\ a derived tree that has a path from i down to label j ,\end{matrix} \\ 0 , & otherwise\end{matrix} \\ f ( i ) = \{ \begin{matrix}j , & \begin{matrix}if i is a label of an auxiliary tree and j is \\ the label for the foot node of such tree ,\end{matrix} \\ 0 , & otherwise .\end{matrix}$$

Matrix A_{f} is an n×n matrix that checks the foot node label transitions, simultaneously. As an embodiment,

$${A}_{f} [ i , j ] = \{ \begin{matrix}j , & \begin{matrix}if i is a label of an auxiliary tree and is \\ the label for the foot node of such tree ,\end{matrix} \\ 0 , & otherwise .\end{matrix}$$

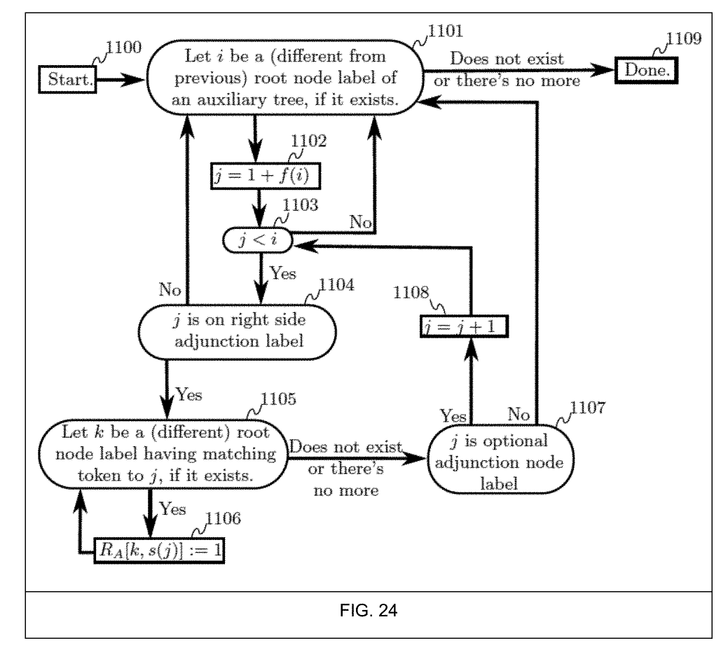

Matrix R_{A} is an n×n matrix that considers the transitions from an auxiliary tree root label to a matching right side adjunction label. FIG. 24 shows an embodiment of the construction of the matrix. All unassigned elements are zero. Construction starts at steps 1100-1101. Step 1101 first searches for tree node label i that is a root node label of an auxiliary tree. If there is none, then instruction moves to step 1109 were the construction of matrix R_{A} is complete. Otherwise, instruction moves to step 1102 where label j is initialized with value 1+f(i). Step 1103 tests whether label j is less than i. If not, then instruction moves back to step 1101 where a different i is searched for. Otherwise, instruction moves to step 1104. For example, if i=13 of FIG. 1, then j=1+f(13)=1+10=11 so step 1103 is satisfied so instruction moves to step 1104. Step 1104 tests label j to see if it is on the right side of an adjunction label. If not, then instruction moves back to step 1101 where a different i is searched for. Otherwise, a root node label k having matching token to j is searched for. If there is one, then instruction moves to step 1106 where a 1 is assigned to the k-th row and s(j)-th column of matrix R_{A}. Continuing our example, j=11 is a right side adjunction label so step 1104 is satisfied and label k=8 has the same token o as label j=11. Hence, 1 is assigned to the 8-th row and 9-th column of matrix R_{A} because s(j)=9. Instruction moves back to step 1105 to search of a different label k. If step 1105 cannot find anymore (or any at all), then instruction moves to step 1107 which tests if label j is an optional adjunction node label. If not, instruction moves back to step 1101. Otherwise, instruction moves to step 1108 where label j is incremented and instruction is moved back to step 1103.

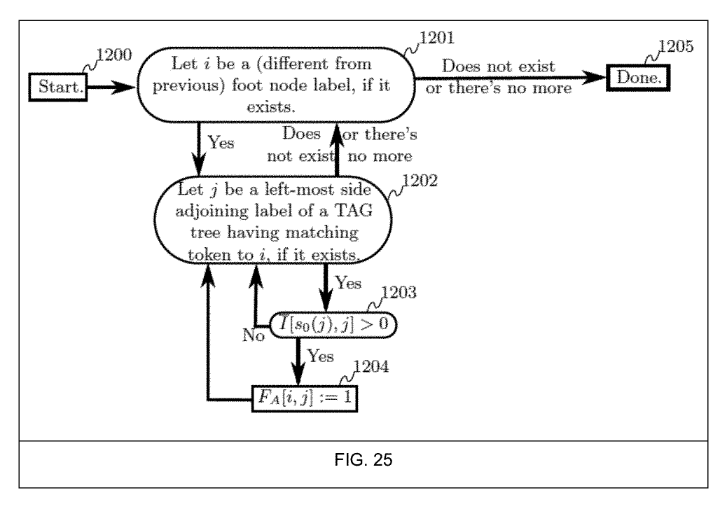

Matrix F_{A} is an n×n matrix that considers the transitions from a foot label to a matching adjunction label on the left-most branch. FIG. 25 shows an embodiment of the construction of the matrix. Construction starts at steps 1200-1201. Step 1201 first searches for tree node label i that is a foot node label. If there is none, then instruction moves to step 1205 were the construction of matrix F_{A} is complete. Otherwise, instruction moves to step 1202 which searches for a left-most side adjoining label j of a TAG tree having matching token to label i. If there is none, instruction moves back to step 1201 where a different foot node label i is searched for. Otherwise, instruction moves to step 1203 which checks if the (j)-th row and j-th column of matrix I is greater than zero. If not, instruction moves back to step 1202. Otherwise, step 1204 assigns 1 the i-th row and j-th column of matrix F_{A} and instruction moves back to step 1202. Matrix Ī and vector s are defined in Embodiment of MVR section.

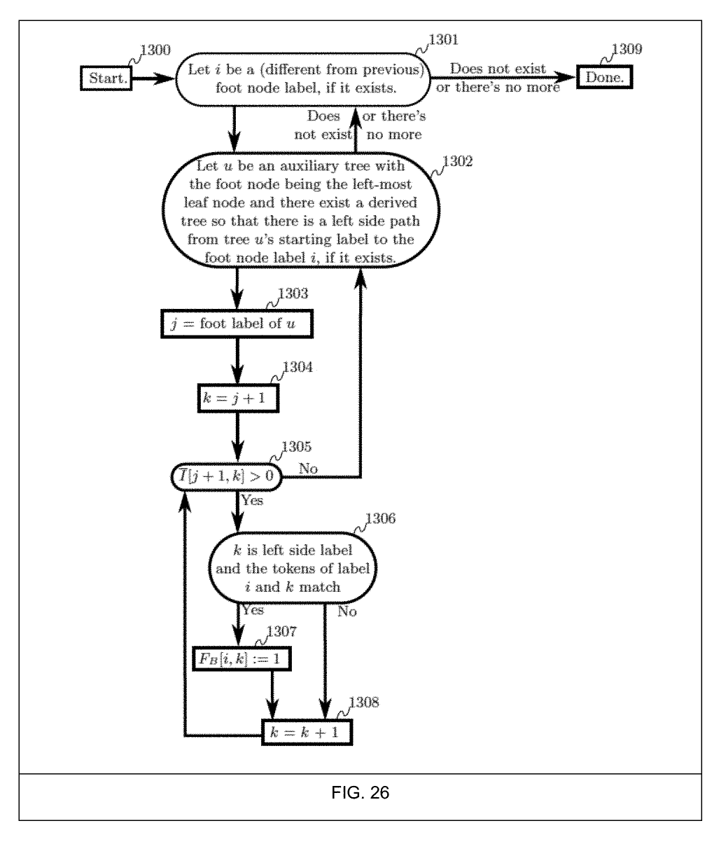

Matrix F_{B} is an n×n matrix that considers the transitions from a foot label to a matching adjunction label not on the right-most branch. FIG. 26 shows an embodiment of the construction of the matrix. Construction starts at steps 1300-1301. Step 1301 first searches for tree node label i that is a foot node label. If there is none, then instruction moves to step 1309 were the construction of matrix F_{B} is complete. Otherwise, instruction moves to step 1302 which searches an auxiliary tree u be with the foot node being the left-most leaf node and there exist a derived tree so that there is a left side path from tree u's starting label to the foot node label i. If there is none, then step 1301 which searches for another foot node label i. Otherwise, step 1303 where the foot node label of auxiliary tree u is saved into storage j. Step 1304 where counter k is initialized with value j+1. Step 1305 tests if the (j+1)-th row and k-th column of matrix I is greater than zero. Matrix I is defined in Embodiment of MVR section. If not, step 1302 searches for another auxiliary tree u. Otherwise, step 1306 tests if counter k is a left side label and the tokens of label i and k match. If not, step 1308 increments counter k and instruction moves back to step 1305. Otherwise, step 1307 assigns 1 the i-th row and j-th column of matrix F_{B} and instruction moves to step 1308. For example, FIG. 1 tree 7 is such tree u because there is a clear left-most path from its root node to its foot node. Additionally, tree 3 and tree 9 as such tree u because nodes with o are optionally adjoined so there is a path from its root to its foot node. Furthermore, tree 1 and tee 10 also qualify because tree 7 can be adjoined to their a node to create a left-most path from their root nodes to their foot node.

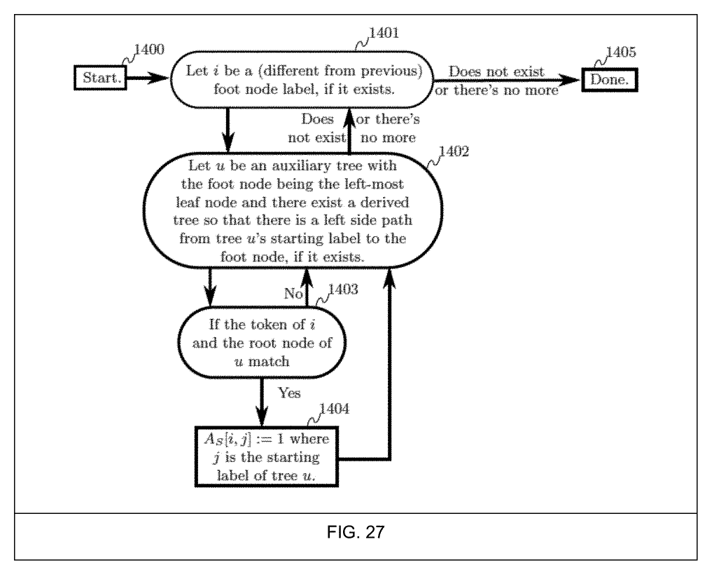

Matrix A_{S} is an n×n matrix that considers the transitions from a root node label of an auxiliary tree to a matching right side adjunction node label. FIG. 27 shows an embodiment of the construction of the matrix. Construction starts at steps 1400-1401. Step 1401 first searches for tree node label i that is a foot node label. If there is none, then instruction moves to step 1405 were the construction of matrix A_{S} is complete. Otherwise, instruction moves to step 1402 which searches an auxiliary tree u be with the foot node being the left-most leaf node and there exist a derived tree so that there is a left side path from tree u's starting label to the foot node label i. If there is none, then step 1401 which searches for another foot node label i. Otherwise, step 1304 tests if the token of label i and the root node of TAG tree u match. If not, instruction moves back to step 1402 where another auxiliary tree u is searched for. Otherwise, step 1404 assigns 1 the i-th row and j-th column of matrix A_{S} and instruction moves to step 1402.

Matrix F_{N} is an n×n matrix that considers the transitions from a foot node label to other nodes. As an embodiment, F_{N}=ĪF_{A}R₁. Matrix F̅_{N} considers the sequence of transitions from F_{N}. As an embodiment,

$${\overline{F}}_{N} = {( 𝕀 - \frac{{F}_{N}}{2 ‖ {F}_{N} ‖} )}^{- 1} .$$

An embodiment of the MVR is then a storage containing subset or all of these vectors or matrices.

### Embodiment of TAG Parser

After the MVR is constructed, the parser is ready to accept tokens to parse. FIG. 3 shows the parsing process as a flow chart. Step 101 checks with the matrix-vector representation (MVR) for the Tree-adjoining grammar (TAG) has been constructed. If not, Step 102 constructs the MVR. Step 103 reads the initial token, step 104 constructs the initial parsing states to the predicted new states and step 105 update the parsing states to predicted new states and construct finished states. Step 106 checks if there are no more tokens to read. If yes, then step 109 checks if there are constructed finished states. If yes, then step 112 reports that the sequence of tokens is valid. Otherwise, step 111 reports that the sequence of tokens is not valid. If there are more tokens to read, step 107 reads the next token. Step 108 filters out all the new states using the rad token, to become the parsing states. Step 110 checks if there are no parsing states after step 108's filtering. If there are no parsing states, then instruction moves to step 111. Otherwise, instruction moves to step 105.

Equivalently, FIG. 4 shows the parsing process as a block diagram. The parsing process starts with the TAG, shown as block 200, to construct the equivalent MVR, shown as block 202. The initial input token is obtained, shown as block 201, and initial parsing states are form from the initial input token and the MVR. The initial parsing states are then updated to predicted new states and construct finished states, shown as block 204. The output of the parser will be a storage of finished states and not finished states. This matches step 105 of FIG. 3. If there are no more tokens, the finished states, shown as block 205, is used to determine whether the sequence of tokens is valid as shown as step 109 of FIG. 3. Otherwise, block 209 reads the next token and block 207 filters the parsing states of block 206, as shown in step 108 of FIG. 3. If there are no parsing states before or after filtering, then step 110 of FIG. 3 is instructed. Block 208 updates the filtered parsing states ready to be updated by step 204. As mentioned in the summary, a state object is a data structure pair containing a label tree and a reference to a node in such label tree. The label tree and reference can instead be replaced with an equivalent object. As shown before, an example would be using a construction direction over label trees for efficiency purposes. For the remainder of this document, we will demonstrate the patent using a mix of construction directions as output of the parser, label trees as input of the parser and the use of construction directions to update the label tree. It is not required that construction directions and label trees be used; any equivalent data structure can be used.

The way the parser constructs the construction directions is by checking the last entry of each of the constructions directions in container F. The last entry will always be a label. Depending on the type of such label, an appropriate action is made to modify storage L, C or Γ. The types are terminal labels (labels under marked with quotes in FIG. 1) substitution nodes (labels under R nodes in FIG. 1), left side adjunction label (labels on the left of a and o in FIG. 1 that are not root and not leaf), right side adjunction label (labels on the right of a and o in FIG. 1), root label of auxiliary tree label (labels on the right of root nodes with a and o in FIG. 1), root label of initial tree label (labels on the right of root nodes with R in FIG. 1) and foot node label (labels under leaf nodes a and o in FIG. 1). After the appropriate action is made, storage F is checked to see if empty. If not, another label-dependent appropriate action is made until F is empty. Otherwise, the updating part is done. Storage C can then become the finished states and storage L can then become the not finished states of FIG. 4.

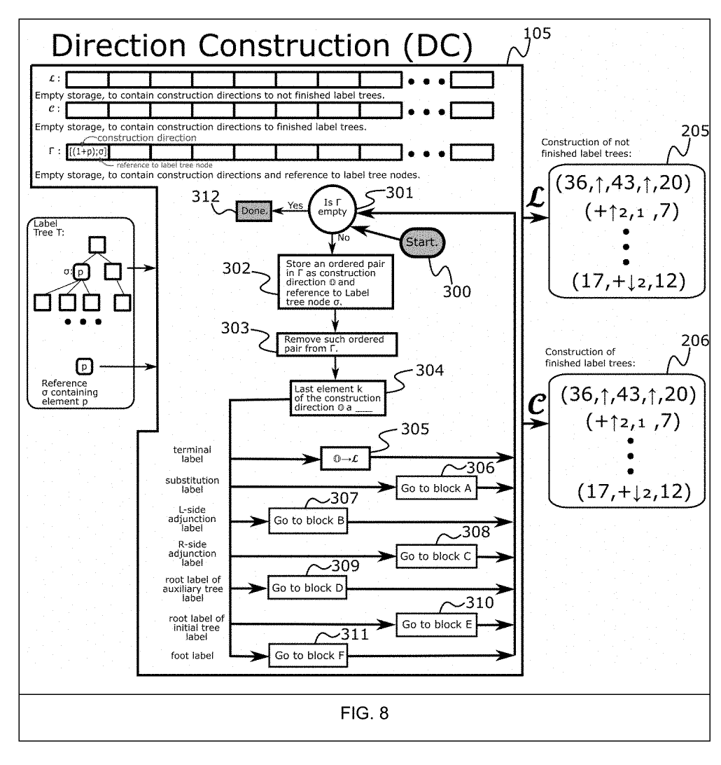

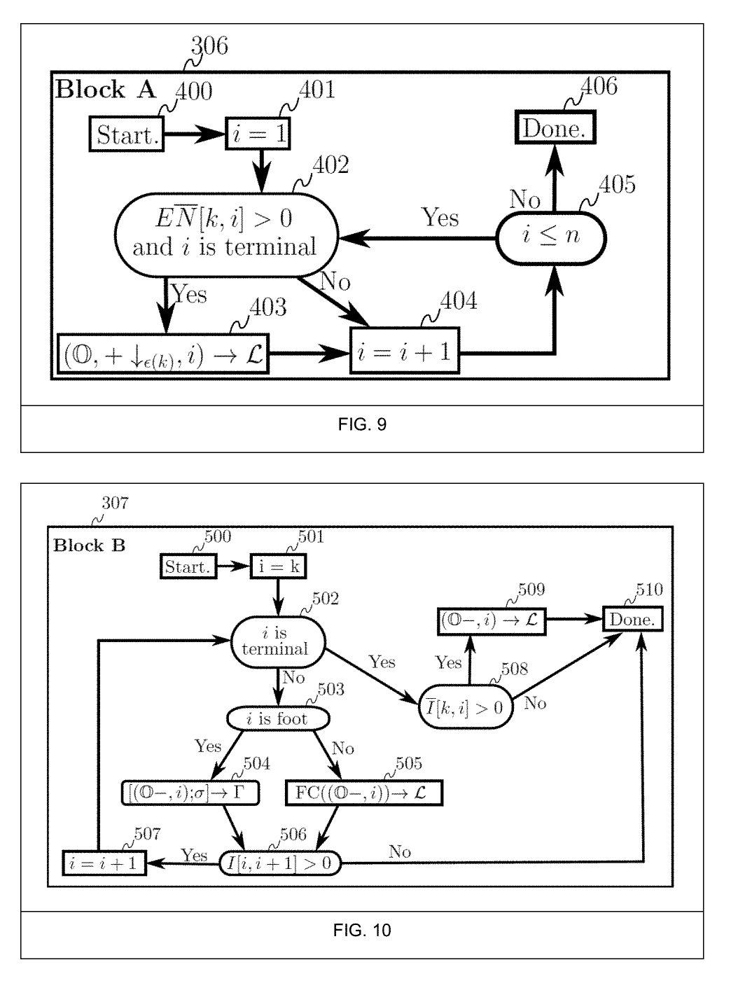

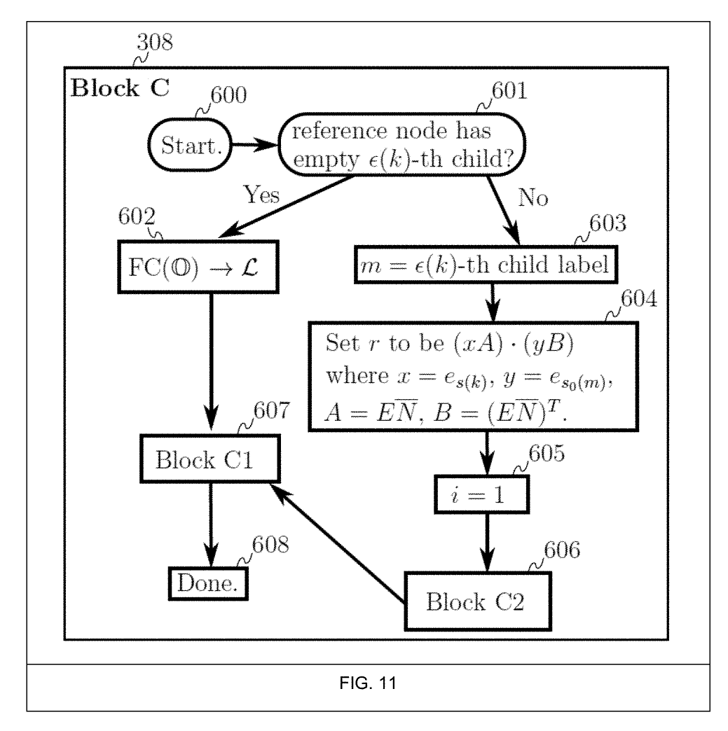

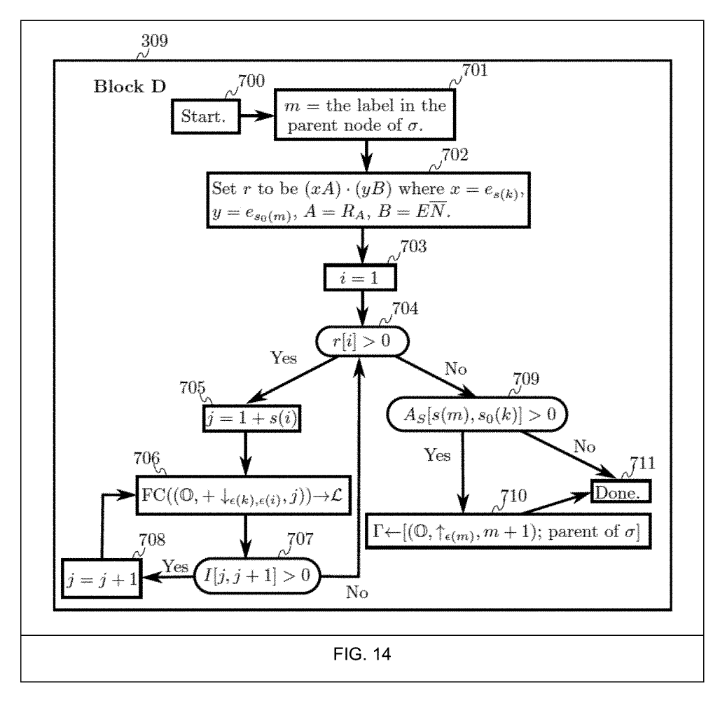

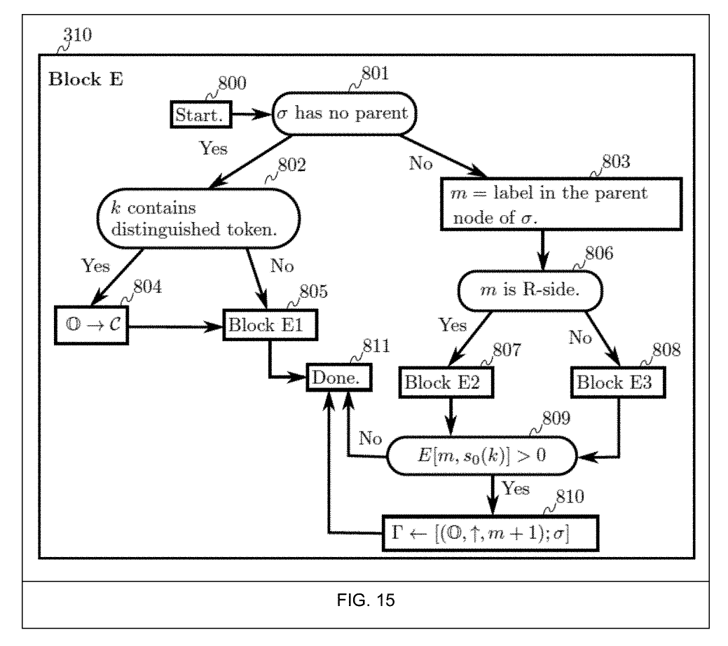

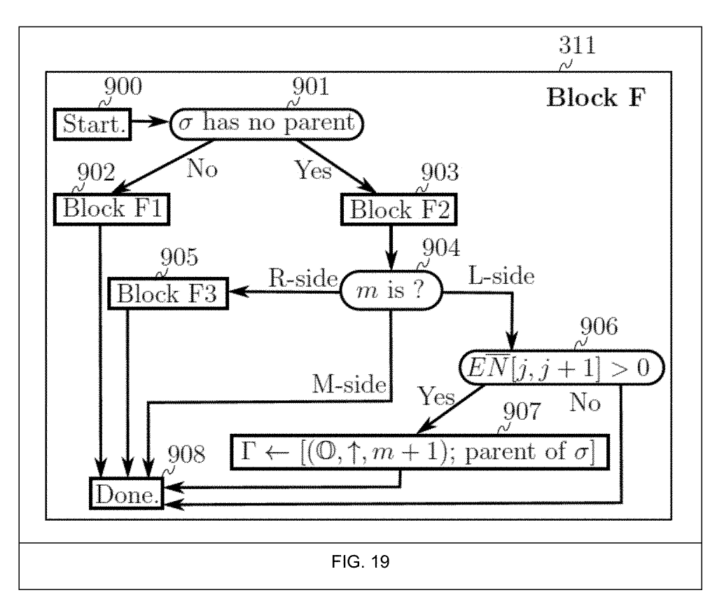

Steps 300-312 of FIG. 8 shows realization of step 105 of FIG. 3 and step 204 of FIG. 4. Step 300 starts the instructions. Step 301 checks if the third storage data structure Γ is empty. If it is, step 312 is executed and the first and second storage data L, C is outputted as the finished states and not finished states of FIG. 4. If not, steps 302-304 are executed. Step 302 and 303 removes the pair in the third storage data structure Γ and assigns it into a temporary object ( [symbol] , σ). Step 304 performs a check on the last element (denoted as k) of [symbol] to determine if it is a terminal label, substitution label, L-side adjunction label, R-side adjunction label, root label of an auxiliary tree label, root label of an initial tree label or a foot label. If it is a terminal label, then step 305 is executed followed by a return to step 301. Step 305 instructs the construction direction [symbol] be saved into the first storage data structure L. If it is a substitution label, then step 306 is executed followed by a return to step 301. Step 306 instructs that block A (shown as FIG. 9) is executed. If it is a L-side adjunction label, then step 307 is executed followed by a return to step 301. Step 307 instructs that block B (shown as FIG. 10) is executed. If it is a R-side adjunction label, then step 308 is executed followed by a return to step 301. Step 308 instructs that block C (shown as FIG. 11) is executed. If it is a root label of an auxiliary tree label, then step 309 is executed followed by a return to step 301. Step 309 instructs that block D (shown as FIG. 14) is executed. If it is a root label of an initial tree label, then step 310 is executed followed by a return to step 301. Step 310 instructs that block E (shown as FIG. 15) is executed. If it is a root label of a foot label, then step 311 is executed followed by a return to step 301. Step 311 instructs that block D (shown as FIG. 19) is executed.

Construction directions, shown as blocks 205 and 206 of FIG. 8, are tuples of symbols that represent the modification of label trees with respect to reference a to a node inside it. They are storage-efficient representation of modifications to the label trees. The ↑ and ↓ corresponds to moving the reference up and down, respectively. The large numbers mean the reference node is assigned to contain that number. The +↓ₘ means a new node is inserted as the m-th child of the reference node and the reference is moved to the new node. The +↓_{m,n} means a new node is inserted between the reference node and its parent node so that the new node is the m-th child of the parent, the reference node is reinterpreted as the n-th child and the reference is later moved to the new node. The +↑ₘ means a new node is inserted between the reference node and the parent node so that the new node has the reference node as the m-th child, the new node is the k-th child of parent node of the reference node if the reference node was the k-th child of its parent node and the reference is moved up to the new node.

FIG. 9 (block A) shows an embodiment for an appropriate action in the case of a substitution label. To understand the notation EN̅[k, i] in FIG. 9, we define A,B,C∈R^{nxn} be square matrices of size n, where n is the number of labels, and i and j be the row and column indices of such matrices, respectively. Furthermore, if C is the matrix multiplication of A and B (C=AB), then notationally, AB[i,j] has the same value as C[i,j]. The construction direction (O, +↓_{∈(k)}, i) is the concatenation of the previous construction O with (↓_{∈(k)},i) where i is a label, and +↓_{∈(k)} means create a node under the current node as its ∈(k)-th child and move the reference to the newly constructed node. The →L means save this construction direction to storage L.

Step 401 initializes a counter i to value 1. Step 402 checks if the k-th row and i-th column of matrix EN̅ is greater than zero and label i is a terminal label. If it is, then step 403 instructs that construction direction [symbol] concatenated with (+↓_{∈(k)}, i) is saved into first storage data structure L. Otherwise, go to step 404 which instructs that i is to be incremented. Step 405 checks if counter i is less than or equal to the number of labels in the Matrix-Vector Representation (MVR) or equivalently the number of columns of matrix EN̅. If it is, then step 402 is repeated. Otherwise, step 406 is executed. Step 406 completes block A instructions moves back to step 301 of FIG. 8.

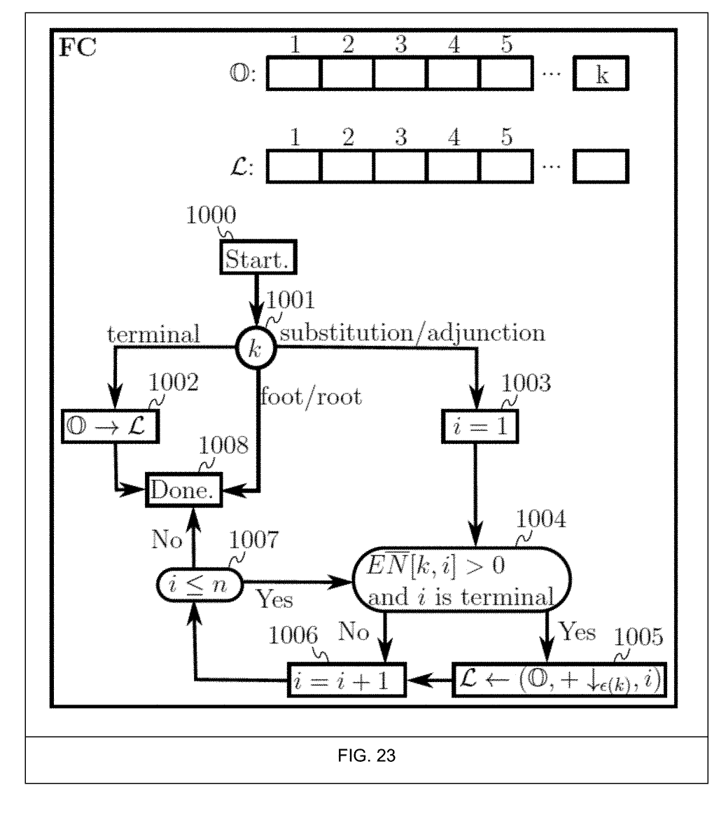

FIG. 10 (block B) shows an embodiment for an appropriate action in the case of a left-side adjunction label (such as label 1, 9 14, 15, 25, 30, 37, 40 and 44 of FIG. 1). Here, [(1+p); σ]→Γ means save the construction direction (1+p) and the reference to a node σ, into storage Γ. FC(( [symbol] −,i))→L means the construction direction ( [symbol] −) is the construction direction [symbol] without O's last element, ( [symbol] −, i) is the construction direction ( [symbol] −) with label i inserted at the end and FC(( [symbol] −,i))→L is inputting ( [symbol] −, i) into Block FC of FIG. 23 as FC's construction direction [symbol] which will then insert more construction directions into storage L.

Step 501 initializes a counter i to value k, defined in FIG. 8 as the last element of the construction direction [symbol] . Step 502 instructs that if i is a terminal label, then step 508 is executed. Step 508 instructs that if the k-th row and i-th column of matrix Ī is greater than zero, then step 509 is executed. Otherwise, block B ends at step 510 and instruction is moved back to step 301 of FIG. 8. The Embodiment of MVR section (below) shows the construction of matrix Ī. Step 509 saves the construction direction ( [symbol] −, i) into first storage data structure L. ( [symbol] −, i) denotes the construction direction [symbol] having the last element removed and value i replacing the last element. If label i is not a terminal, then step 503 checks if it is instead a foot label. If it is, then step 504 instructs that a pair [( [symbol] −, i); σ] is saved into third storage data structure Γ. Otherwise, instruction block FC, shown in FIG. 23, is executed with construction direction ( [symbol] −, i) as input and block FC's output is saved into the first storage data structure L. Step 506 tests whether the i-th row and (i+1)-th column of matrix I is greater than zero. If it is, then counter i is incremented and step 502 is repeated. Otherwise, step 510 is executed, completes block B instructions and control moves back to step 301 of FIG. 8.

FIG. 23 (block FC) has as input a construction direction [symbol] which contains the label k as the last element. As output, it will modify (through insertion) storage L depending on the type of label k, which can be a terminal node label, foot node label, root node label, substitution node label or adjunction node label. Block FC is initialized with a construction directions [symbol] as input, with the last element being a tree node label k, and initialized with an empty list of construction directions L. It starts with steps 1000 and 1001. Step 1001 tests whether label k is a foot or root label, terminal label or substitution or adjunction label. If label k is a foot or root label, then instruction completes block FC at step 1008 and list L is passed to the block that triggers it. If label k is a terminal label, then the input construction direction [symbol] is saved into list L and instruction passes to step 1008 ending block FC. If label k is a substitution or adjunction label, then instruction moves to step 1003. Step 1003 initializes counter i be value 1. Step 1004 checks if the k-th row and i-th column of matrix EN is greater zero. Construction of matrix E and matrix N are defined in Embodiment of MVR section. If not, then counter i is incremented and instruction passes to step 1007. Step 1007 checks if counter i is less than or equal to the number of labels. If not, then instruction moves to step 1008. Otherwise, instruction moves back to step 1004. If step 1004 is satisfied, then instruction moves to step 1005. Step 1005 saves construction direction ( [symbol] , +↓_{∈(k)}, i) into list L and instruction moves to step 1006.

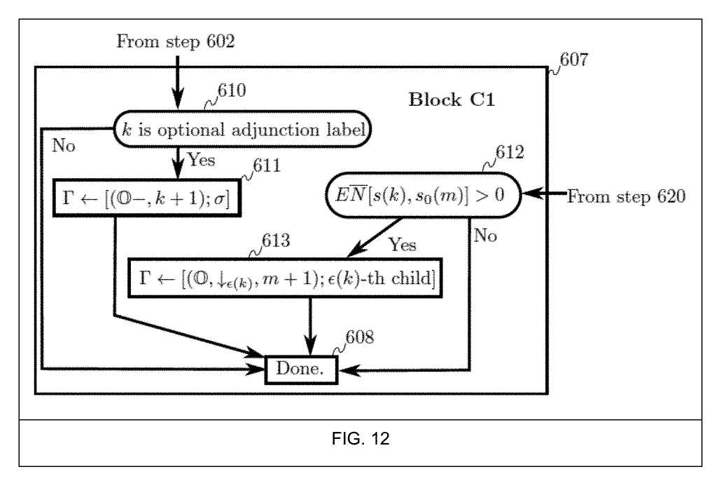

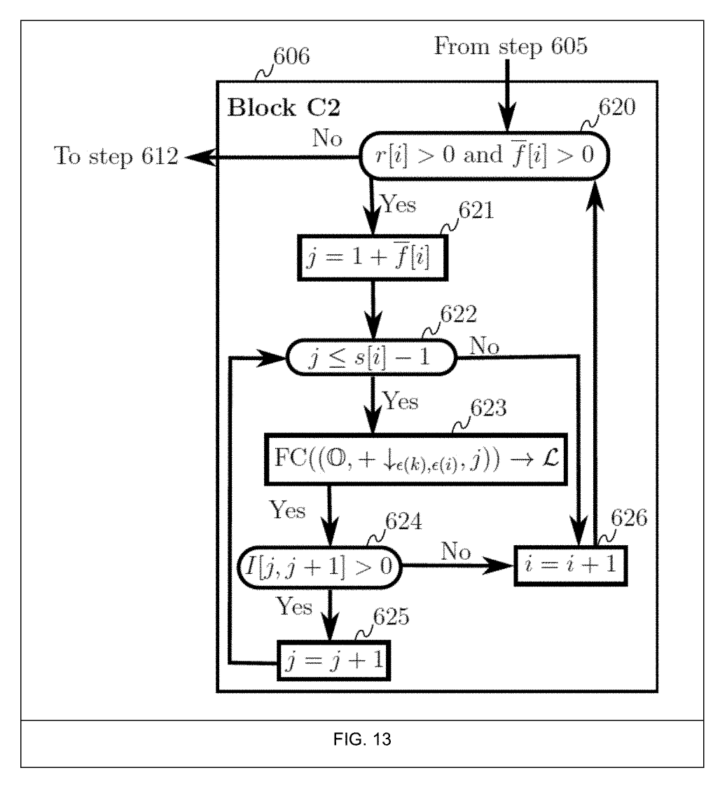

FIG. 11 (block C) shows an embodiment for an appropriate action in the case of a right-side adjunction label. A check is made on whether the reference node, σ in FIG. 9, has empty (or nonexistent) ∈(k)-th child. If yes, this leads to the execution of Block C1 of FIG. 12. If not, this leads to the execution of Block C2 of FIG. 13 and then to the execution of Block C1. Here, eₛ₍ₖ₎ is a vector of zeros except at the s(k)-th location which is 1. Similarly, eₛ_{₀}₍ₘ₎ is a vector of zeros except at the s₀(m)-th location which is 1. Expression (xA)·(yB) means that vector x is multiplied with matrix A, y is multiplied with matrix B, their result is multiplied element-wise and assigned to vector r; this is different from the dot product. It should be mentioned that this embodiment is vector-matrix multiplication xA but the same formulation can be done using matrix-vector multiplication.

Step 601 tests whether the reference node σ has an empty child at the ∈(k) location. If it does, then step 602 and step 607 specifies that instruction block FC, shown in FIG. 23, is executed with construction direction [symbol] as input and block FC's output is saved into the first storage data structure L and instruction block C1, shown in FIG. 12, is executed. If otherwise, instructions 603-607 is executed. And after step 607, step 608 completes block C instructions and control moves back to step 301 of FIG. 8. Step 603 stores the ∈(k)-th child label of reference node σ, denoted here as m. Step 604 computes vector r is computed as the element-wise vector multiplication (shown as ·) of vectors eₛ₍ₖ₎EN̅ and eₛ_{₀}₍ₖ₎(EN̅)^{T} where (EN̅)^{T} is the matrix transpose of matrix EN̅ and eⱼ if a column vector with a 1 in the j-th element and all other indices having zero value. Step 605 initializes i to the value 1. Step 606 instructs block C2, shown in FIG. 13, be executed.

In FIG. 12 (block C1), construction direction (O, ↓_{∈(k)},m+1) is the concatenation of construction direction O with construction direction (↓_{∈(k)},m+1) where ↓_{∈(k)} means move down to the ∈(k)-th child of the reference node and m+1 is the label after label m which is to replace the content of the ∈(k)-th child. The ∈(k)-th child is the ∈(k)-th child of the node referenced by σ, the reference pulled from storage Γ.

Block C1 has two starting locations depending which step block C executes block C1 from. If step 602 of block C is executed, then block C1 starts its execution from step 610. If step 606 of block C is executed, then block C1 starts its execution at step 612. Equivalently, because step 606 executes block C2, step 612 proceeds step 620 of block C2. Step 610 tests whether label k is an optional adjunction label. If not, step 608 instructs that execution of block C1 ends and instruction goes to step 608 of block C. If yes, then step 611 instructs that pair [( [symbol] −, k+1); σ] is saved into first storage data structure L. ( [symbol] −, k+1) denotes that construction direction [symbol] having the last element removed and value k+1 replacing the last element. Step 612 tests whether the s(k)-th row and s₀(m)-th column of matrix EN̅ is greater than zero. If not, step 608 instructs that execution of block C1 ends and instruction goes to step 608 of block C. If yes, then step 613 instructs that pair [( [symbol] , +↓_{∈(k)},m+1); ∈(k)-th child] is saved into first storage data structure L.

In FIG. 13, block C2 starts after step 605 of block C and proceeds to step 620. Step 620 tests whether the i-th element of vector r and vector f̅ are greater than zero. Counter i is initialized from step 605 of block C, vector r is defined from step 604 of block C and Embodiment of MVR section (below) shows the construction of vector f̅. If test of step 620 is not true, then block C2 moves to step 612 of block C1. Otherwise, it proceeds to step 621 where value 1+f̅ [i] is stored. Step 622 tests whether j≤s[i]−1. If not, then step 626 instructs counter i be incremented and proceed back to step 620. Otherwise, step 623 specifies that instruction block FC, shown in FIG. 23, is executed with construction direction [symbol] concatenated with (+↓_{∈(k), ∈(i)}, j) as the input and block FC's output is saved into the first storage data structure L. Next, step 624 checks if the j-th row and (j+1)-th column is greater than zero. If not, then step 626 instructs counter i be incremented and proceed back to step 620. Otherwise, step 625 instructs counter j is incremented and proceeds back to step 622. +↓_{∈(k), ∈(i)} means the insertion of a label tree node under the reference node as the ∈(k)-th child, the current ∈(k)-th child becomes the ∈(i)-th child of the inserted label tree node and label j is contained in the inserted label tree node. FC(( [symbol] , +↓_{∈(k), ∈(i)}, j))→L means ( [symbol] , +↓_{∈(k), ∈(i)}, j) is inputted into Block FC, of FIG. 23, as FC's construction direction [symbol] which will then insert more construction directions into storage L.

FIG. 14 (block D) shows an embodiment for an appropriate action in the case of a root label of an auxiliary tree. The parent node of a refers to the label tree node parent of the label tree reference node σ. Step 701 stores the label in the parent node of Label Tree reference σ denoted here as m. Step 702 computes vector r is computed as the element-wise vector multiplication (shown as ·) of vectors eₛ₍ₖ₎R_{A} and eₛ₍ₘ₎(EN̅)^{T} where (EN̅)^{T} is the matrix transpose of matrix EN̅ and eⱼ if a column vector with a 1 in the j-th element and all other indices having zero value. Construction of matrix R_{A}, matrix EN̅, matrix I, matrix Aₛ, vectors, vector s₀ and vector E are defined in Embodiment of MVR section. Step 703 initializes counter i to value 1. Step 704 tests whether the i-th element of vector r is greater than zero. If not, step 709 tests whether the s(m)-th row and s₀(k)-th column of matrix Aₛ is greater than zero. If not, then step 711 is executed, completing block D instructions and control moves back to step 301 of FIG. 8. If yes, then pair [( [symbol] , ↑, m+1); parent of σ] is saved into the third storage data structure Γ and step 711 is executed, completing block D instructions and control moves back to step 301 of FIG. 8. If step 704 is not true, then step 705 initializes counter j to value 1+s(i). Step 706 specifies that instruction block FC, shown in FIG. 23, is executed with construction direction ( [symbol] , +↓_{∈(k), ∈(i)}, j) as input and block FC's output is saved into the first storage data structure L. Step 707 tests whether the i-th row and (i+1)-th column of matrix I is greater than zero. If not, then step 707 proceeds back to step 704. Otherwise, step 708 increments j and proceeds back to step 706.

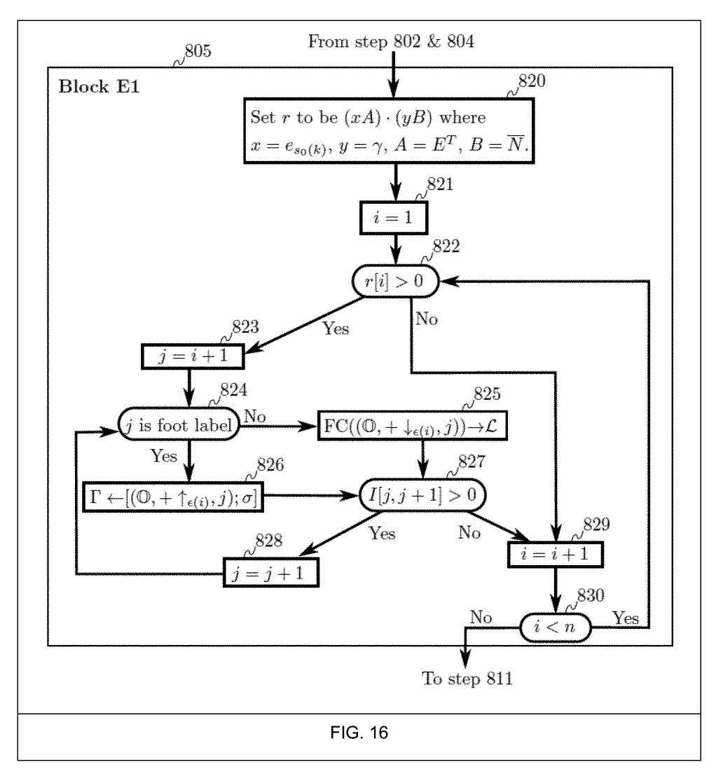

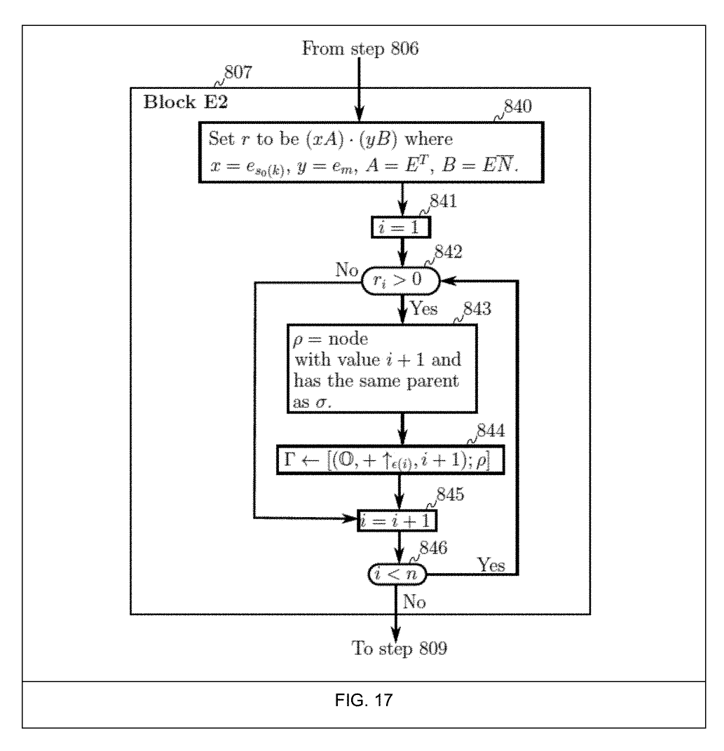

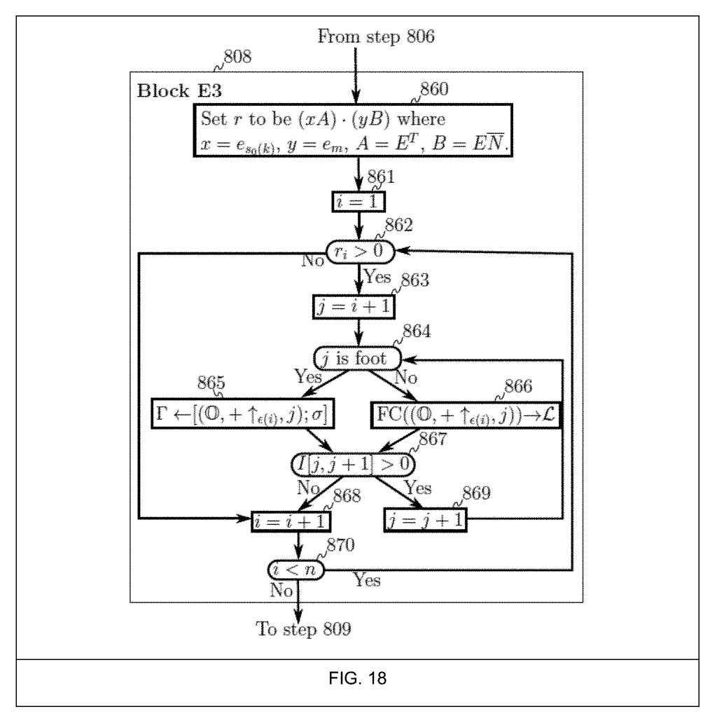

FIG. 15 (block D) shows an embodiment for an appropriate action in the case of a root label of an initial tree. Depending on whether the reference node σ has a parent node (meaning reference node σ is not a root node), one of the two branches of executions is performed. The first branch leads to the insertion of the construction direction [symbol] into storage C and execute Block E1, of FIG. 16. The second branch executes either Block E2, of FIG. 17 or Block E3, of FIG. 18, depending on whether the parent node label m is on the right side. Step 830 has n to be the number of labels present in the TAG. Step 843 constructs a node containing the label after label i, i+1, and has the same parent as reference node σ.

Step 801 tests wither reference a has a parent node. If yes, then step 802 tests if label k contains a distinguished token. If no, then step 805 instructs block E1, shown in FIG. 16, be executed followed by step 811, which completes block E instructions and control moves back to step 301 of FIG. 8. Otherwise, step 804 instructs that the construction direction [symbol] is saved into the second storage data structure before step 805 is executed. If step 801 is not true, then step 803 stores the label in the parent node of a, denoted here as m. Step 806 tests whether label m is an R-side label. If yes, then step 807 instructs block E2, shown in FIG. 17, be executed followed by step 809. Otherwise, step 808 instructs block E3, shown in FIG. 18, be executed followed by step 809. Step 809 tests whether the m-th row and s₀(k)-th column of matrix E is greater than zero. If not, then step 811 completes block E instructions and control moves back to step 301 of FIG. 8. Otherwise, pair [( [symbol] , ↑, m+1); σ] is saved into the third storage data structure Γ before proceeding to step 811.

Step 820 (FIG. 16 block E1) computes vector r is computed as the element-wise vector multiplication (shown as ·) of vectors eₛ_{₀}₍ₖ₎E^{T} and γN̅ where E^{T} is the matrix transpose of matrix E and eⱼ if a column vector with a 1 in the j-th element and all other indices having zero value. Construction of matrix E, matrix I, matrix N̅, vector s₀, and vector γ are defined in Embodiment of MVR section. Step 821 initializes counter i be value 1. Step 822 tests whether the i-th element of vector r is greater than zero. If not, then step 829 increments counter i and step 830 checks if counter i is less than the number of labels. If not, then instruction completes block E1 and moves to step 811 of FIG. 15. Otherwise, instruction moves back to step 822. If step 822 is satisfied, step 823 initializes label j to value i+1. Step 824 tests if label j is not a foot label, then step 825 specifies that instruction block FC, shown in FIG. 23, is executed with construction direction ( [symbol] , +↓_{∈(i)}, j) as input and block FC's output is saved into the first storage data structure L. Otherwise, step saves pair [( [symbol] , +↑_{∈(i)}, j); σ] into third storage data structure Γ. In either case, step 827 proceeds, testing if the j-th row and (j+1)-th column of matrix I is greater than zero. If not, step 829 proceeds it. Otherwise, step 828 increments label j and instruction moves back to step 824.

Step 840 (FIG. 17 block E2) computes vector r is computed as the element-wise vector multiplication (shown as ·) of vectors eₛ_{₀}₍ₖ₎E^{T} and eₘEN̅ where E^{T} is the matrix transpose of matrix E and eⱼ if a column vector with a 1 in the j-th element and all other indices having zero value. Construction of matrix E, matrix N̅ and vector s₀ are defined in Embodiment of MVR section. Step 841 initializes counter i be value 1. Step 842 tests whether the i-th element of vector r is greater than zero. If not, then step 845 increments counter i and step 846 checks if counter i is less than the number of labels. If not, then instruction completes block E2 and moves to step 809 of FIG. 15. If step 842 is satisfied, step 843 instructs the construction of a Label Tree node ρ containing label value i+1 and the node has reference node σ as the parent. Step 844 saves pair [( [symbol] , +T_{∈(i)}, i+1); ρ] into third storage data structure Γ and proceeds to step 845.

Step 860 (FIG. 18 block E3) computes vector r is computed as the element-wise vector multiplication (shown as ·) of vectors eₛ_{₀}₍ₖ₎E^{T} and eₘEN̅ where E^{T} is the matrix transpose of matrix E and eⱼ if a column vector with a 1 in the j-th element and all other indices having zero value. Construction of matrix E, matrix I, matrix N̅ and vector s₀ are defined in Embodiment of MVR section. Step 861 initializes counter i be value 1. Step 862 tests whether the i-th element of vector r is greater than zero. If not, then step 868 increments counter i and step 870 checks if counter i is less than the number of labels. If not, then instruction completes block E3 and moves to step 809 of FIG. 15. Otherwise, instruction moves back to step 862. If step 862 is satisfied, step 863 initializes label j to value i+1. Step 864 tests if label j is a foot label. If yes, then step 865 saves pair [( [symbol] , +↑_{∈(i)}, j); σ] into third storage data structure Γ. Otherwise, step 825 specifies that instruction block FC, shown in FIG. 23, is executed with construction direction ( [symbol] , +↑_{∈(i)}, j) as input and block FC's output is saved into the first storage data structure L. In either case, step 867 tests if i-th row and (i+1)-th column of matrix I is greater than zero. If not, then instruction moves to step 868. Otherwise, step 869 increments label j and proceeds back to step 864.

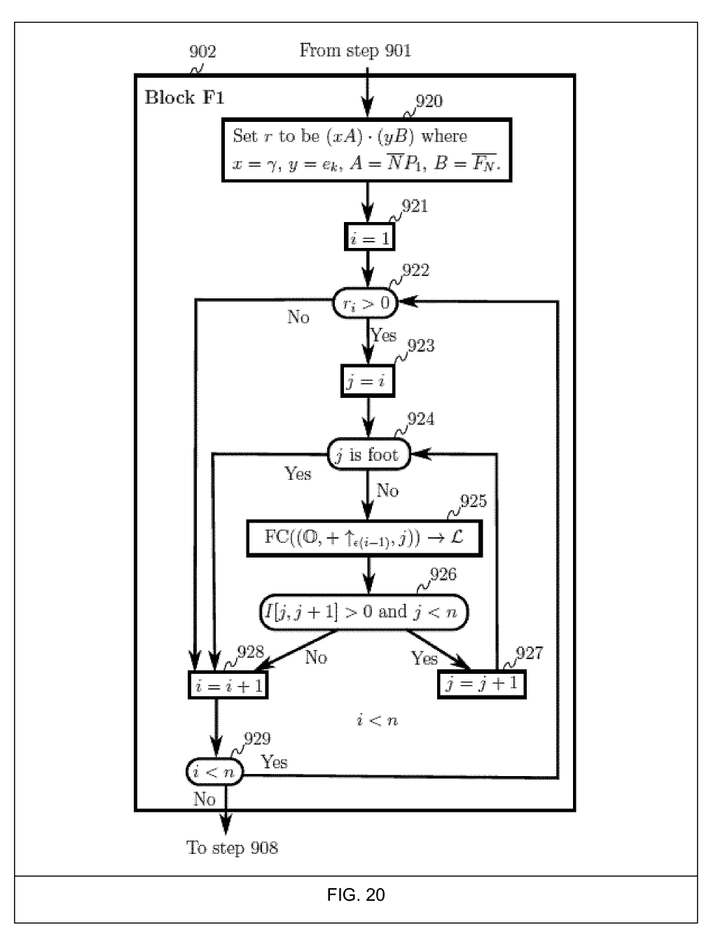

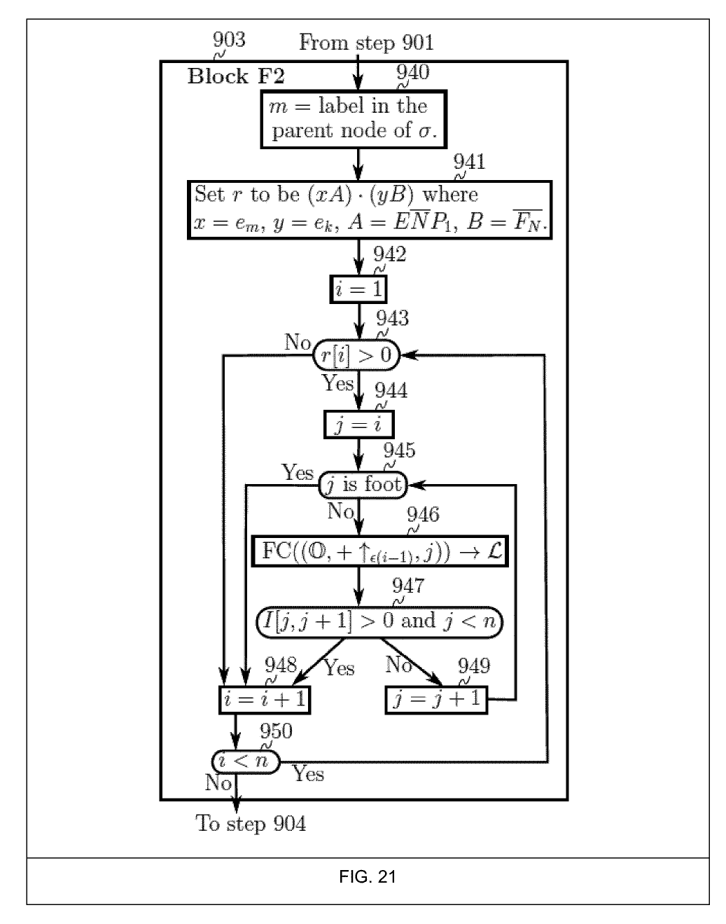

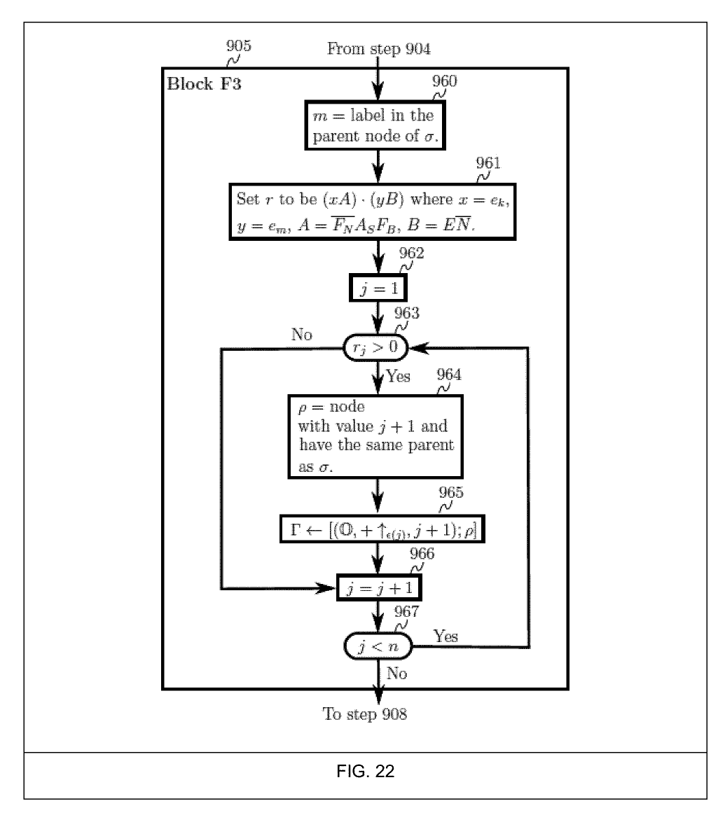

FIG. 19 (block F) shows an embodiment for an appropriate action in the case of a foot label. Depending on whether reference node σ has no parent (meaning reference node σ is a root node), either Block F1, of FIG. 20, or Block F2, of FIG. 21 is executed. After Block F2, a determination is made on whether the parent node label m is on the right side, left side or middle side (middle side means foot node label, substitution node label or terminal node label). If it is on the right side, Block F3, of FIG. 22, is executed. If it is a middle side, then nothing further is performed. Step 963 constructs a node containing the label after label j, j+1, and has the same parent as reference node σ.

Step 901 tests whether reference node σ has a parent node. If not, instruction moves to block F1, shown in FIG. 20, followed by step 908, which completes block F instructions and control moves back to step 301 of FIG. 8. Otherwise, step 903 executes block F2, shown in FIG. 21, followed by step 904. Step 904 tests whether label m is R-side, M-side or L-side. If M-side, then instruction moves to step 908, which completes block F instructions and control moves back to step 301 of FIG. 8. If R-side, then step 905 executes block F3, shown in FIG. 22, followed by step 908, which completes block F instructions and control moves back to step 301 of FIG. 8. If L-side, then the j-th row and (j+1)-th column of matrix EN̅ is tested for value greater than zero. Construction of matrix E and matrix N̅ are defined in Embodiment of MVR section. If not, then instruction moves to step 908, which completes block F instructions and control moves back to step 301 of FIG. 8. Otherwise, pair [( [symbol] , ↑, m+1); parent of σ] is saved into third storage data structure Γ followed by step 908, which completes block F instructions and instruction moves back to step 301 of FIG. 8.

Step 921 (FIG. 20 block F1) computes vector r is computed as the element-wise vector multiplication (shown as ·) of vectors γN̅P₁ and eₖF̅_̅{̅N̅}̅ where eⱼ if a column vector with a 1 in the j-th element and all other indices having zero value. Construction of matrix I, matrix N̅, matrix P₁, matrix F̅_̅{̅N̅}̅ and vector γ are defined in Embodiment of MVR section. Step 921 initializes counter i be value 1. Step 922 tests whether the i-th element of vector r is greater than zero. If not, then step 928 increments counter i and step 929 checks if counter i is less than the number of labels. If not, then instruction completes block F1 and moves to step 908 of FIG. 19. Otherwise, instruction moves back to step 922. If step 922 is satisfied, then step 923 initializes counter j with value i and step 924 checks if label j is a foot label. If yes, then step 928 increments counter i. Otherwise, step 925 specifies that instruction block FC, shown in FIG. 23, is executed with construction direction ( [symbol] , +↑ₑ₍ᵢ₋₁₎, j) as input and block FC's output is saved into the first storage data structure L. Next, step 926 checks if the j-th row and (j+1)-th column of matrix I is greater than zero and j<n. If not, then step 928 increments counter i. Otherwise, step 928 increments counter j and instruction moves back to step 924.

Step 940 (FIG. 21 block F2) assigns the label in the parent node of reference node σ to label m. Step 941 computes vector r is computed as the element-wise vector multiplication (shown as ·) of vectors eₘEN̅Pᵢ and eₖF̅_̅{̅N̅}̅ where eⱼ if a column vector with a 1 in the j-th element and all other indices having zero value. Construction of matrix I, matrix E, matrix N̅, matrix P₁, and matrix F̅_̅{̅N̅}̅ are defined in Embodiment of MVR section. Step 942 initializes counter i be value 1. Step 943 tests whether the i-th element of vector r is greater than zero. If not, then step 948 increments counter i and step 950 checks if counter i is less than the number of labels. If not, then instruction completes block F2 and moves to step 904 of FIG. 19. Otherwise, instruction moves back to step 943. If step 943 is satisfied, then step 944 initializes counter j with value i and step 945 checks if label j is a foot label. If yes, then step 948 increments counter i. Otherwise, step 946 specifies that instruction block FC, shown in FIG. 23, is executed with construction direction ( [symbol] , +↑_{∈(i-1)}, j) as input and block FC's output is saved into the first storage data structure L. Next, step 947 checks if the j-th row and (j+1)-th column of matrix I is greater than zero and j<n. If not, then step 948 increments counter i. Otherwise, step 949 increments counter j and instruction moves back to step 943.

Step 960 (FIG. 22 block F3) assigns the label in the parent node of reference node σ to label m. Step 961 computes vector r is computed as the element-wise vector multiplication (shown as ·) of vectors eₖF̅_̅{̅N̅}̅A_{S}F_{B} and eₘEN̅ where eⱼ if a column vector with a 1 in the j-th element and all other indices having zero value. Step 962 initializes counter j be value 1. Step 963 tests whether the i-th element of vector r is greater than zero. If not, then step 966 increments counter j and step 967 checks if counter j is less than the number of labels. If not, then instruction completes block F3 and moves to step 908 of FIG. 19. Otherwise, instruction moves back to step 963. If step 963 is satisfied, then step 964 instructs the construction of a Label Tree node ρ containing label value j+1 and the node has reference node σ as the parent. Step 965 saves pair [( [symbol] , +↑_{∈(i)}, i+1); ρ] into third storage data structure Γ and proceeds to step 966.

From FIG. 8, once the execution of the appropriate action is made depending on the type of label, the process is repeated with a new object (new construction direction [symbol] and reference σ) from storage Γ. Once Γ is empty, the DC block (and hence step 105 of FIG. 3) is done. Storage L becomes the not finished label trees. Storage C becomes the finished label trees. Shown in FIG. 3, there are still more tokens to read, the label tree constructed from the storage L (or an equivalent object) is compared to the input token (in step 108). If there is no parsing state that matches the read token, then the parser reports that the sequence of tokens is not valid (in step 111). When there is no more tokens to read (in step 106), if storage C is empty (in step 107), then the parser reports that the sequence of tokens is not valid (in step 111). Otherwise, if storage C is not empty, then the parser reports that the sequence of tokens is valid.

1. A method for parsing a sequences of tokens in a tree-adjoining grammar comprising:
employing matrix-vector representation (MVR) of the tree-adjoining grammar;
constructing and updating parsing states for each of the objects;
tracking parsing state for each of the tokens; and
determining validity of the tokens or predict the next tokens.

2. The method for parsing a sequences of tokens in a tree-adjoining grammar of claim 1, wherein the parsing states are label trees, which are tree data structures used to store unique identification, called labels, of the nodes of the trees in the tree-adjoining grammar.

3. The method for parsing a sequences of tokens in a tree-adjoining grammar of claim 1, wherein the parsing states are constructions directions, which are a sequence of modifications to a label tree.

4. The method for parsing a sequence of tokens in a tree-adjoining grammar of claim 1, wherein the MVR is specifically defined as a set of matrices and vectors comprising:
transitioning from one label to the follow-up label in the same TAG;
transitioning from one label to the follow-up label to a different TAG tree; and
employing starting labels, a label that is on the left side of the first child of the root node, corresponding to the first possible token of a sequence of tokens that is valid in the tree-adjoining grammar.

5. The method for parsing a sequence of tokens in a tree-adjoining grammar of claim 4 with the construction of transition matrix R_{A} comprising:
iterating right side adjunction label j for each of the auxiliary trees;
searching to find corresponding root node labels k having a matching token to label j; and
assigning entry in matrix R_{A} to mark that the elementary trees of labels j and can be attached together.

6. The method for parsing a sequence of tokens in a tree-adjoining grammar of claim 4 with the construction of transition matrix F_{A} comprising:
iterating foot node label i;
searching to find corresponding root node labels k having a matching token to label j; and
assigning entry in matrix F_{A} to mark that the elementary trees of labels j and can be attached together.

7. The method for parsing a sequence of tokens in a tree-adjoining grammar of claim 4 with the construction of transition matrix F_{B} comprising:
iterating foot node label i;
searching for auxiliary trees u with the foot node being the left-most leaf node and there is a left side path from such tree u's starting label to the foot node and there exist a derived tree so that there is a left side path from tree u's starting label to the foot node; and
assigning entry in matrix F_{B} to mark that the elementary trees of labels j and can be attached together.

8. The method for parsing a sequence of tokens in a tree-adjoining grammar of claim 4 with the construction of transition matrix A_{S} comprising:
iterating foot node label i;
searching for auxiliary trees u with the foot node being the left-most leaf node and there is a left side path from such tree u's starting label to the foot node and there exist a derived tree so that there is a left side path from tree u's starting label to the foot node; and
assigning entry in matrix A_{S} to mark that the elementary trees of labels j and can be attached together, if the token of the foot node and the root node of tree u match.

9. The method for parsing a sequences of tokens in a tree-adjoining grammar of claim 1, wherein the step of constructing and updating parsing states, called the DC block, for each of the objects includes steps of utilizing storage F to store updates to the parsing state;
checking of the current label in said update for a terminal label, substitution label, left-side (L-side) adjunction label, right-side (R-side) adjunction label, root label of an initial tree, root label of an auxiliary tree and foot label;
handling each of these label cases; and
outputting updated parsing state.

10. The method of claim 9 with the use of the FC block comprising:
utilizing storage [symbol] to store updates to the parsing state;
checking current label k for a terminal, foot, root, substitution or adjunction node label; and
handling of each of these label cases by either the construction direction [symbol] is stored into storage [symbol] , construction direction [symbol] is appended and then stored into storage [symbol] , or nothing is to be done.

11. The method of claim 9 with the use of Block A defined to handle the substitution node case of the DC block comprising:
iterating terminal labels i;
employing transition matrix E that transitions from one label to another label of another TAG tree label;
employing matrix EN̅ to find the set of terminal label i to append the construction direction and store into storage [symbol] where transition matrix E that transitions from one label to another label of another TAG tree label and transition matrix N̅ that performs multiple transitions from one label to the follow-up label in the same TAG tree or to another label of another TAG tree label; and
storing appended construction direction [symbol] and store into storage [symbol] .

12. The method of claim 9 with the use of Block B defined to handle the left side adjunction node case of the DC block comprising:
iterating labels i starting with the input label k;
employing transition matrix I that transitions from one label to the follow-up label in the same TAG tree to determine if further iteration is needed;
employing transition matrix Ī, that considers a sequence of label transitions from matrix I, to determine if a modified construction direction ( [symbol] −, i) is to be stored into storage [symbol] ;
employing FC block to get the construction direction to be stored into storage [symbol] ; and
the storage of a construction direction and a reference to a node σ is stored into storage Γ.

13. The method of claim 9 with the use of Block C defined to handle the right side adjunction node case of the DC block comprising:
checking whether the reference node has an empty ∈(k)-th child;
employing the FC block to obtain the parsing update;
employing transition matrix I that transitions from one label to the follow-up label in the same TAG tree;
employing transition matrix E that transitions from one label to another label of another TAG tree label;
employing transition matrix N that transitions from one label to the follow-up label in the same TAG tree or to another label of another TAG tree label;
employing vector ∈ that defines the label to child index correspondence;
employing vector s that specifies the left and right side label correspondence;
employing vector f̅ that specifies the foot node label transitions;
checking whether label k is optional adjunction label; and
employing matrix and vector multiplication (xA)·(yB) to perform filtering of labels.

14. The method of claim 9 with the use of Block D defined to handle the root label of auxiliary tree case of the DC block comprising:
checking whether the reference node has an empty ∈(k)-th child;
employing the FC block to obtain the parsing update;
employing of transition matrix I that transitions from one label to the follow-up label in the same TAG tree;
employing transition matrix E that transitions from one label to another label of another TAG tree label;
employing transition matrix N that transitions from one label to the follow-up label in the same TAG tree or to another label of another TAG tree label;
employing transition matrix A_{S} that transitions from a root node label of an auxiliary tree to a matching right side adjunction node label;
employing transition matrix R_{A} that transitions from an auxiliary tree root label to a matching right side adjunction label;
employing vector ∈ that defines the label to child index correspondence;
employing vector s₀ that the starting label of the TAG tree containing specified label;
employing vector s that specifies the left and right side label correspondence; and
employing matrix and vector multiplication (xA)·(yB) to perform filtering of labels.

15. The method of claim 9 with the use of Block E defined to handle the root label of initial tree case of the DC block comprising:
checking whether the label k contains distinguished token;
checking whether the label is an R-side label or foot node label;
employing the FC block to obtain the parsing update;
employing transition matrix I that transitions from one label to the follow-up label in the same TAG tree,
employing transition matrix E that transitions from one label to another label of another TAG tree label;
employing transition matrix N that transitions from one label to the follow-up label in the same TAG tree or to another label of another TAG tree label;
employing vector ∈ that defines the label to child index correspondence;
employing vector s₀ that the starting label of the TAG tree containing specified label;
employing vector s that specifies the left and right side label correspondence;
employing vector f̅ that specifies the foot node label transitions; and
employing matrix and vector multiplication (xA)·(yB) to perform filtering of labels.

16. The method of claim 9 with the use of Block F defined to handle the foot label case of the DC block comprising:
checking whether the label k contains distinguished token;
checking whether the label is an L-side label, M-side label, R-side label or foot label;
employing the FC block to obtain the parsing update;
employing transition matrix I that transitions from one label to the follow-up label in the same TAG tree;
employing transition matrix E that transitions from one label to another label of another TAG tree label;
employing transition matrix N that transitions from one label to the follow-up label in the same TAG tree or to another label of another TAG tree label;
employing transition matrix P₁ that transitions from one label to the follow-up label in the same TAG tree;
employing transition matrix A_{S} that transitions from a root node label of an auxiliary tree to a matching right side adjunction node label;
employing transition matrix F_{B} that transitions from a foot label to a matching adjunction label not on the right-most branch;
employing transition matrix F̅_{N} matrix that considers multiple transitions from a foot node label to foot nodes and then to other nodes;
employing vector ∈ that defines the label to child index correspondence;
employing vector γ that defines the starting terminal labels; and
employing matrix and vector multiplication (xA)·(yB) to perform filtering of labels.
